(19) United States
(12) Patent Application Publication
(10) Pub. No.: US 2005/0168617 A1
(43) Pub. Date: Aug. 4, 2005

(54) Cover for a monitoring camera

(75) Inventors: Martin Timm, Suederstapel (DE); Michael Fischell, Stuhr (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/017,503

(22) Filed: Dec. 20, 2004

(30) Foreign Application Priority Data
Dec. 23, 2003 (DE) 103 60 762.5

(51) Int. Cl. H04N 5/225

(52) U.S. Cl. 348/335; 348/373

(57) ABSTRACT

Cover is described for a monitoring device, especially for a monitoring camera with objectives and a tube enclosing it, as well as an illumination device and/or a motion detector arranged outside of tube. The cover of the invention is designed in one piece and is essentially transparent only to infrared radiation. The cover is preferably designed as a plate-like cover panel, wherein this is connected to tube. By means of this configuration of the cover of the invention for a monitoring device, it is almost invisible to a viewer from the outside and, as a result, well concealed. In addition, because of the good concealment properties of the cover of the invention, large objectives with strong light transmitting capacity could be used for the monitoring camera. In addition, a simplified design is obtained, because of the one-piece structure of cover, wherein the surface facing outward is configured flat.

### BACKGROUND OF THE INVENTION

The invention relates to a cover device. In particular, the present invention relates to a cover device, e.g. for a monitoring device, especially for a monitoring camera with an objective and a tube closing the objective, as well as an illumination device and/or a motion detector which may be arranged outside of the tube.

Monitoring devices, especially monitoring cameras and motion detectors, are widely used in all security-relevant areas. Such monitoring cameras are often used, for example, in the cabins of civil aircraft, in order to monitor the cockpit door, the passenger doors, the passenger cabin or other regions prone to hazards as inconspicuously as possible. Such monitoring cameras preferably operate in the non-visible, near-infrared region, but can also be sensitive in the region of light visible to the human eye. In order to guarantee reliable use of the monitoring camera even in darkness or during night flights, infrared illumination is additionally provided to light up the surveyed area.

Spatial separation between the camera optics and the infrared illumination is state of the art. During integration of the infrared emitter in a housing, the cover panel is usually made from several different materials. The structure of the cover panel made of different materials, among other things, prevents reflections that can cause a serious deterioration in image quality.

In an already known variant of a cover, the monitoring camera and its objective are enclosed by a non-transparent plastic tube, in order to largely prevent blinding of the monitoring camera by the infrared illumination. A plastic or glass cover panel, transparent in the visible range, is arranged in the tube on the side facing the surveyed object. The monitoring camera or motion detector is therefore visible to the human eye from the outside, so that concealment of the monitoring device with the already known cover panel is adversely affected. The illumination device enclosed in the tube can be formed from a ring of infrared-emitting diodes (IRED) arranged in a circle and uniformly spaced from each other. Ordinarily the camera objective, the tube and the illumination device are designed concentric with reference to the optical axis of the monitoring camera. However, geometric arrangements deviating from this are also used. On the peripheral outside edge of the tube, a cover panel, almost exclusively transparent to infrared light, is connected on all sides, in order to inconspicuously conceal at least the illumination device from a viewer. Because of this overall free-part design configuration of the already known cover, it is ensured, among other things, that at least the illumination device is not readily visible to the human eye. The top of such a cover, however, is not completely flat, because the upper edge of the tube facing outward, the top of the cover panel of the tube transparent to visible light and the top of the cover panel transparent exclusively to infrared light do not form a flat surface.

A drawback in this already known variant of a cover for a monitoring device is that its three-part structure is demanding in design, owing to the necessary connections of the individual parts, and therefore costly. In particular, manufacturing connection of the individual parts is difficult and therefore cost-intensive. In addition, effective concealment of the monitoring camera and therefore the entire arrangement is not present, because of the cover panel of the tube transparent to visible light. For example, small, so-called spy hole objectives with relatively weak imaging must be used, in order to ensure sufficient concealment of the monitoring camera. Finally, the already known cover does not have a continuous flat surface outward, so that cleaning work is hampered.

### SUMMARY OF THE INVENTION

There may be a need to avoid the aforementioned drawbacks of the known variant of a cover panel for a monitoring camera or motion detector. The cover according to an exemplary embodiment of the present invention may be designed in one piece and is essentially transparent only to infrared radiation.

As a result of the cover, transparent essentially only to infrared radiation, good concealment of the monitoring camera is offered, so that strong imaging objectives with a large objective diameter can be used, without adversely affecting concealment on this account. Because of the one-piece design of the cover, cost-effective production is provided. In addition, the cleaning cost is reduced, because of the flat configuration of the cover.

Modifications and advantageous embodiments of the invention are set forth in additional patent claims. Additional advantages are apparent from the following detailed description of the invention.

### BRIEF DESCRIPTION OF THE DRAWINGS

FIG. 1 shows a side view of the cover in section.

FIG. 2 shows a top view of the cover of FIG. 1.

### DETAILED DESCRIPTION

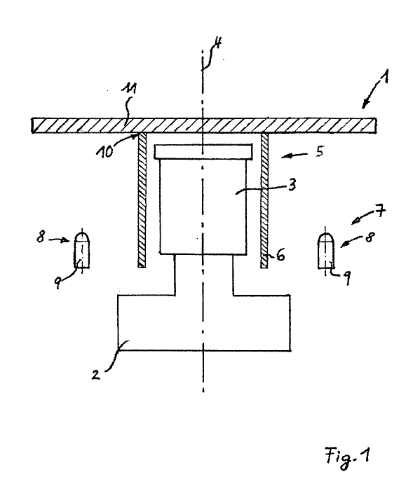

FIG. 1 shows the cover 1 of the invention for a monitoring camera 2 and/or a motion detector, not further shown in the drawing, in a side view. The monitoring camera 2 is preferably sensitive essentially to radiation in the near-infrared range and is equipped with an additional objective 3.

Both the monitoring camera 2 and the objective 3 are arranged concentrically around an optical axis 4. The objective 3 and the monitoring camera 2 are enclosed by an anti-glare device 5. In the depiction of cover 1 of FIG. 1, the anti-glare device 5 is designed as a tube 6, arranged rotationally symmetric around optical axis 4. However, other geometric configurations of the anti-glare device 5 deviating from this are conceivable. For example, the anti-glare device 5, deviating from a depicted circular cross sectional geometry, can have an elliptic, square, rectangular or polygonal cross section.

The tube 6 of FIG. 1 mostly serves to avoid fadeout of the monitoring camera 2 by the related illumination device 7. The tube 6 is formed from a material, non-transparent for visible light and for radiation in the near-infrared range. Colored plastic, metallic materials or the like are considered as material for the tube.

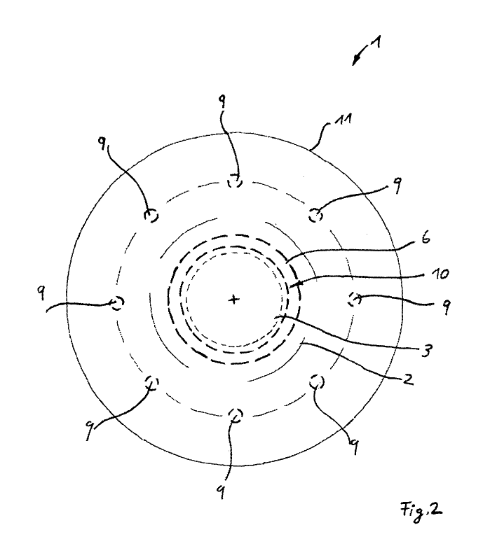

In the depiction of FIG. 1, the illumination device 7 comprises a total of eight illuminating devices 8, arranged in circular fashion around the optical axis 4, and each having the same spacing relative to the adjacent illuminating device (cf. FIG. 2). The illumination device 7 is required, in order to guarantee sufficient exposure of the monitoring camera 2 and illumination of the surveyed object being recorded by it, for example, during complete darkness, as in the case of night flights. Additional illumination of the surveyed area of the monitoring camera 2 can also be necessary in daylight.

The illuminating devices 8 as depicted are designed as infrared-emitting diodes 9 that essentially emit radiation in the near-infrared range. Deviating from the depicted view of the illumination device 7 in FIG. 1, 2, a different number of infrared-emitting diodes 9 and/or a deviating geometric arrangement of the infrared-emitting diodes in space are possible, without departing from the fundamental idea of the invention. Finally, illuminating elements based on a technology different from the depicted infrared emitting diodes 9 can also be used as illuminating devices 8. Infrared lasers, infrared laser diodes or special incandescent lamps and the like are considered in this context. Infrared-emitting diodes 9, in comparison with other illuminating devices, have higher lifetime, are largely insensitive to vibrations and are therefore low-maintenance. Consequently, in conjunction with the cover 1 of the invention, infrared-emitting diodes are preferably used to illuminate the surveyed area or surveyed space situated in front of the camera.

A flat, plate-like cover panel 11 that forms the actual cover 1 lies on a peripheral edge 10 of tube 6, pointed away from the monitoring camera 2. The cover panel 11 is made from a continuous, one-piece material essentially transparent only to radiation in the near-infrared range. The cover panel 11 is preferably made from plastic, in order to achieve low weight and, at the same time, high rupture safety. As an alternative, glass can also be used, because of the better optical properties under some circumstances. However, plastic has an advantage over glass as material, in that no hazardous splinters are formed in the event of destruction of cover panel 11. As an alternative, other materials or material combinations can be used.

The cover panel 11 lies on the edge 10 of tube 6 (cf. FIG. 1). As an alternative to this configuration, a connection of tube 6 to cover panel 11, for example, by gluing, is also conceivable, so that it forms an integral component of the cover panel 11. As an alternative, the tube 6 can be screwed to the cover panel 11, soldered or connected firmly to it in some other way. With particular advantage, tube 6, during production of the cover panel 11, is molded onto it in an injection molding process.

Because of the plate-like cover panel 11, essentially transparent only to infrared radiation, but not light in the visible range, a viewer cannot easily recognize the illumination device 7 or the monitoring camera 2 with the objective 3 connected in front from the outside. A significant gain in security for the monitoring mentioned in the introduction is obtained from this in the field of civil aviation, because of better concealment of the monitoring camera by the cover panel 11 of the invention.

In addition, the cover panel 11 can also be mirrored, in order to further reduce the recognizability of the monitoring camera 2 and/or the motion detector. In addition, a mirrored version of the cover panel 11 is adopted for better optical integration of cover 1 in special, stipulated interior surroundings of a passenger aircraft and other means of transport. The cover panel 11, for example, could be designed as a large area mirror that leaves the monitoring camera 2 with the illumination device 7 and/or the motion detector almost invisible to the observer. The cover 1 of the invention also is adopted for optimal concealment of large objectives 3 with high light transmitting capacity, and therefore with strong imaging capability. The use of spy hole objectives with weak imaging capability is no longer required. Finally, the cover 1 guarantees optimal mechanical objective protection.

FIG. 2 shows a top view of the cover 1 of the invention with the flat plate-like cover panel 11. In FIG. 2, the cover panel 11 is designed circular. The cover panel 11, however, can also have an arbitrary geometric shape deviating from this. Thus, it is conceivable, for example, to give the plate-like cover panel 11 a square, rectangular, polygonal or elliptical shape. In addition to cover panel 11, it can also have a cross section deviating from the flat configuration and be corrugated or provided with surface structure.

The infrared-emitting diodes 9 are positioned beneath the cover panel 11, indicated with dashed lines. The monitoring camera 2 with objectives 3 is concentrically enclosed by tube 6 (also indicated with a dashed line). Here again, deviating geometric arrangements are possible. For example, the tube 6 and/or the objectives 3 should be positioned eccentrically relative to monitoring camera 2.

Owing to the configuration of the plate-like cover panel 11 of the invention as a one-piece component, a distinctly simpler production, and therefore more cost-effective production is obtained in comparison with the already known variants. Rigid integration of tube 6 in the cover panel 11 is particularly advantageous, because the number of individual parts is reduced by this.

Instead of monitoring camera 2, or in addition to it, a motion detector (not further depicted in the drawing) can also be provided, which is also positioned in the region of monitoring camera 2. The motion detector has at least two sensor regions in known fashion to detect motion of a surveyed object in the surveyed area of the monitoring camera 2. In addition, the motion sensor is configured, so that it is particularly sensitive to infrared radiation. A movement is detected by the motion detector in known fashion, wherein different sensor regions of the motion detector respond in time succession to the occurring impinging infrared radiation and release corresponding signals to an evaluation unit.

The objective 3 in this variant is designed as a Fresnel lens, at least in areas, which diverts incoming light along the optical axis 4 to different regions of the motion detector, and therefore is adopted for motion recognition of the surveyed objects in front of the monitoring camera. The cover panel 11 is configured accordingly, which again diverts the incoming light to specific regions of objective 3. As an alternative, the objective 3 can be left out in this variant, wherein case the cover panel 11 is then formed as a Fresnel lens that again detects incoming radiation to certain regions of the motion detector.

By combining the monitoring camera 2 with a motion detector, it is possible, for example, to only allow a recording by a monitoring camera 2 to begin, if a surveyed object approaches the surveyed region of the monitoring camera 2 and a change in the surveyed region being observed therefore occurs.

As a result of the one-piece continuous cover panel 1 of the invention, essentially transparent only to infrared radiation, good concealment of the monitoring camera 2 is offered, so that large objectives 3 with strong imaging properties can be used. The monitoring camera 2 can be integrated almost “invisibly” in stipulated internal areas of civil passenger aircraft, because of the cover panel 11 of the invention. As a result of the one-piece design of cover panel 11, cost-effective production is provided. Loosening of parts by vibration, etc. is likewise impossible, because of the preferably one-piece version of the cover panel 11. In addition, the cleaning expense is reduced as a result of the flat surface of the cover panel 11.

Application areas for the illumination device of the invention are also luggage and product areas in civil and military aircraft. The illumination device of the invention, however, is not restricted to use in the field of civil passenger aviation. Applications in other security-relevant areas are conceivable, for example, room monitoring in buildings, monitoring of outside surfaces, as well as passenger stops in public local and long-distance mass transit.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. Cover device for a monitoring camera with an objective and a tube enclosing the objective, the tube having a continuous edge directed away from the monitoring camera, as well as an auxiliary device arranged outside of tube, the auxiliary device having at least one of an illumination device and a motion detector, the cover device comprising:
a cover;
wherein the cover is arranged in one piece and is essentially transparent only to infrared radiation;
wherein the cover is arranged as a plate-like cover panel that lies on the continuous edge of the tube; and
wherein the cover panel is one of ellipsoidal or round.

2. The cover device of claim 1, wherein the cover panel is adapted on the tube.

3. The cover device of claim 1, wherein the cover panel is adapted such that the monitoring camera, with the tube and the illumination device or the motion detector, are almost invisible from the outside to the human eye.

4. The cover device of claim 1, wherein the cover panel is formed from at least one of plastic and glass.

5. The cover device of claim 1, wherein the cover panel has a mirroring.

6. The cover device of claim 1, wherein the cover panel is almost non-transparent to visible light.

7. The cover device of claim 1, wherein the tube is non-transparent essentially to visible light and radiation in the near-infrared range.
